(19) United States
(12) Patent Application Publication
(10) Pub. No.: US 2009/0174179 A1
(43) Pub. Date: Jul. 9, 2009

(54) Three dimensional cover and product representation and method of manufacture; and a method for advertising using a cover and/or representation

(75) Inventors: Matthew Marshall, Edinburgh (GB); Michael Paterson, Edinburgh (GB); Guy Hundleby, Edinburgh (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Magnetic Advertising Company Limited

(21) Appl. No.: 12/316,791

(22) Filed: Dec. 16, 2008

Related U.S. Application Data
(63) Continuation-in-part of application No. 11/902,369, filed on Sep. 20, 2007, now abandoned.

(51) Int. Cl. B42D 15/00

(52) U.S. Cl. 283/67; 283/56

(57) ABSTRACT

A product representation made of a mouldable sheet of material sized and shaped to correspond to the size of a real corresponding product wherein at least a portion of said sheet is moulded according to a three dimensional pattern or image of the real corresponding product.

### RELATED APPLICATION

This application is a continuation-in-part of co-pending application Ser. No. 11/902,369, which is incorporated herein by reference in its entirety.

### FIELD OF THE INVENTION

The invention relates to the field of publishing and product marketing, more particularly, to the area of magazine publishing and marketing of products in order to minimise theft. The device and method according to the invention is designed for commercial purposes to advertise and increase awareness of products.

### BACKGROUND

Three dimensional posters made from moulded plastic material have previously been produced to attract public attention. These posters have been printed in large format, approximately 600 mm×450 mm in size and often bigger and are designed to attract attention in the fast moving consumer goods sector, to advertise and promote food and drink products at point of sale.

Organisations within the film, entertainment and publishing sectors have previously used unusual covers, such as lenticular covers, on magazines, DVDs, books, CDs, computer games and video games to increase presence of their products in retail outlets as special editions and to appeal to collectors.

Organisations within the film, entertainment and publishing sectors have previously used cover mounts, such as printed games, toys and figurines, on magazines, books, DVDs, CDs, computer games and video games to enhance shelf presence and increase sales of their products.

Certain consumer products have high intrinsic value and are susceptible to being stolen despite the high levels of security currently applied to goods and products. This is particularly the case with small consumer electronics goods such as games, games consoles and cameras, etc.

### DESCRIPTION OF THE INVENTION

There remains however a need for a device and method according to the present invention for commercial purposes to advertise and increase awareness of products.

A further need exists for a device and method according to the present invention which overcomes the risk of loss due to theft and the associated monetary loss.

According to the invention there is described a new item which can be used to increase the presence and stand out of a magazine. The item according to the invention is a product representation made of a mouldable sheet of material sized and shaped to correspond to the size of a real corresponding product wherein at least a portion of said sheet is moulded according to a three dimensional pattern or image of the real corresponding product.

The product representation according to the invention can be advantageously sized and shaped to correspond to the size of a real corresponding product and may further include artwork which is applied to the sheet. Also at least a portion of the sheet may be moulded as either protuberances or recesses to represent the form of the real corresponding product.

Another object of the invention is a method of using a representation according to the invention in a method of advertising, the purpose of such method is to increase sales and attract the attention of the customer. The method comprises the step of providing, adapting and displaying a 3-dimensional representation of a real corresponding product. Preferably the method, further comprising exchanging the representation of the product for the real corresponding product at a payment point.

### BRIEF DESCRIPTION OF THE DRAWINGS

One or more embodiments of the invention are herein described, by way of example, with reference to the accompanying drawings, in which:

FIG. 1 is an example of a 3-dimensional product representation in accordance with an embodiment of the present invention.

FIG. 2 is a flow chart showing the method steps in accordance with an embodiment of the present invention.

### DETAILED DESCRIPTION OF THE INVENTION

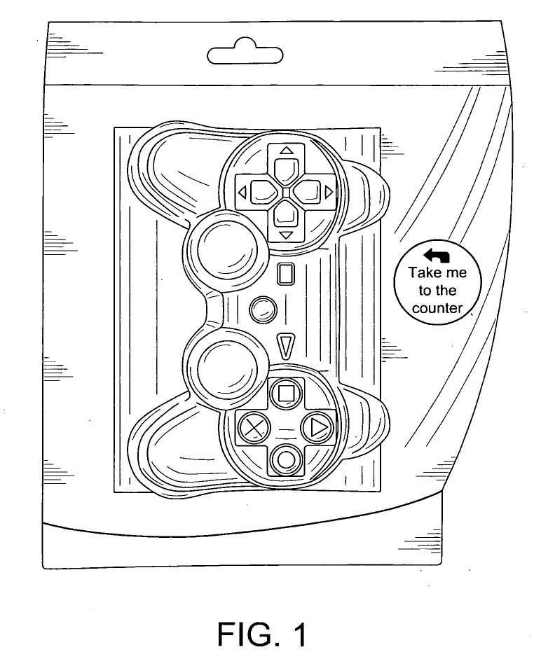

To manufacture an item according to the invention, an image (supplied by client) is selected to be produced as 3-dimensional cover or 3-dimensional product representation as shown in FIG. 1. This representation is then produced by creating a mould sized to correspond with the magazine cover dimensions or the dimensions of the real product. This mould could be used to stamp out the 3-dimensional representation, which may then be overprinted using moulding and printing techniques currently known in the art.

The required artwork is developed using a Computer Aided Design (CAD) system and the size of the image may be modified to match the requested dimensions e.g. to fit the cover of a magazine or to be accommodated on a particular presentation stand.

A mould is then created that will be used to stamp out the shaped 3-dimensional representation or cover. This mould may be produced by a laser cutting a metal block, or other type of method of making a mould. The details of the mould may also be generated by the design created from the CAD artwork.

Sheets of material, such as ATBC (Acetyl tributyl citrate) PVC, may be selected as the material which is to be printed. The precise material may be selected to offer a best fit in terms of number of images per sheet of material i.e. it may be cheaper to manufacture “best fit” sized sheets of material in order to keep waste to a minimum. The mould is then placed within a stamping press jig or equivalent and a first set of samples are obtained by the jig.

The mould is then modified where necessary in order to achieve the next layer of printing required to produce an accurate 3-dimensional representation of the two-dimensional image. This process of remoulding and reprinting can be repeated as many times as necessary to obtain a representation or cover which is of sufficient quality and definition.

There may be a set of moulds for each cover or product representation to avoid the need for remoulding, particularly when a large number of covers or representations are being formed.

The covers or the representation are then printed using standard print machinery. Usually printed samples using standard 4 colour process techniques are used to achieve accurate colours. Inks to be used are, for example, standard plastic printing inks. Some modifications can then be made to ensure that the colours are accurate to the desired specification or artwork and mass production is carried out using a mould and printing technique which meets the necessary standards of quality and definition.

During the printing process enough time should be allowed for the product to dry between application of different colours in order to prevent the cover or representation from being marked or damaged.

It is advantageous to box and pack the product on-line. In the case of the magazine cover the printed product may be stacked one on top of the other as this has the benefit of protecting the 3-dimensional shape of each cover. In the case of the product representation the packaging may be formed as part of the process used to form the representation. This means that the original image was in the form of the product and its associated packaging. The mould and printing method may need to be adapted appropriately to accommodate this.

In the case of the magazine cover, the 3-dimensional cover is then positioned on the external cover of the magazine and either attached to the cover or maintained in place by a, preferably transparent, plastic wrapping.

The use of such 3-dimensional covers is a very effective way of attracting potential consumer attention. Moreover the fact that the cover is detachable from the magazine itself provides the additional advantage of allowing easy handling of the magazine by separating the 3-dimensional cover from the magazine. In addition, the detachable cover can be kept by the purchaser as a novelty item for decorative purpose.

In the case of the 3-dimensional representation of the product, the representation is used instead of the real product in the marketing and sales of the real product. The representation is presented to customers on an appropriate marketing stand and customers select the product they wish to purchase based on the representation. In this way, the real product is not displayed on the marketing stand and thus cannot be stolen. However, the customer is presented with a look and feel equivalent to that of the real product through the 3-dimensional representation. Weights may be added to the 3-dimensional representation to ensure that the product representation weighs roughly the same as the real products.

The products for which representations may be formed are limitless. However, it is expected that this invention would be best suited to electronic goods, such as games, games consoles, joysticks and the like. This is due to the fact that these types of goods are appropriately sized to suit the process under which the representations are made. Also, these goods are often susceptible to theft.

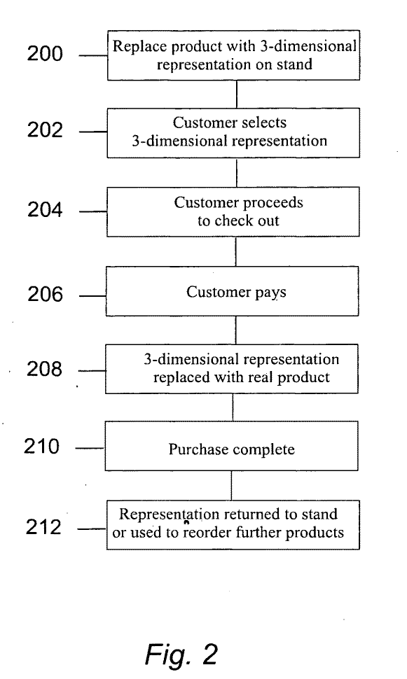

Referring now to FIG. 2, the methods steps, for advertising and subsequent purchase of a product using a representation, are explained. At step 200 the real product is replaced with a 3-dimensional representation on a sales or marketing stand. A customer selects a product by selecting the 3-dimensional representation at step 202. The customer then proceeds to the checkout at step 204 and pays for the product at step 206. The customer is then given the product to replace the representation at step 208. The purchase is then complete at step 210. Since the customer has paid before the product is given to the customer there is no risk of the product being stolen. This ensures retail outlets and suppliers have a much safer environment in which to present and advertise their products and to sell them. At the step 212 the representation may be returned to the marketing stand or may be used to order further products associated with the representation.

An outlet selling specific products may a have an equivalent number of representations to the number of products in their stock. Alternatively, the outlet may have just a small number of representations and replace them on the stand whenever a product is sold. Irrespective of the number of representations, using representations of the product ensures that suppliers and retailers do not have products stolen; but ensures that customers feel like they are viewing or buying something real and recognizable.

We claim:

1. A product representation made of a mouldable sheet of material sized and shaped to correspond to the size of a real corresponding product wherein at least a portion of said sheet is moulded according to a three dimensional pattern or image of the real corresponding product.

2. A product representation as claimed in claim 1, further including artwork which is applied to the sheet.

3. A product representation as claimed in claim 1 wherein at least a portion of the sheet is moulded as either protuberances or recesses to represent the form of the real corresponding product.

4. The product representation as claimed in claim 1, further including a representation of the packaging associated with the real corresponding product.

5. The product representation as claimed in claim 1, being attachable to a flat article such as a magazine, a DVD, a video game, a book, a CD etc.

6. An advertising method which comprises the step of providing, adapting and displaying a 3-dimensional representation of a real corresponding product.

7. The method as claimed in claim 6, further comprising exchanging the representation of the product for the real corresponding product at a payment point.

8. The method of claim 6, further comprising producing a product representation using moulding and artwork processes.
